(19) United States
(12) Patent Application Publication
(10) Pub. No.: US 2002/0078317 A1
(43) Pub. Date: Jun. 20, 2002

(54) First-in, first-out (FIFO) memory with moving boundary

(75) Inventor: Hiroyuki Yasoshima, Cupeertino, CA (US)

Correspondence Address: McDERMOTT, WILL & EMERY, 600 13th Street, N.W., Washington, DC, 20005-3096, US

(73) Assignee: Matsushita Electric Industrial Co., Ltd.

(21) Appl. No.: 09/739,265

(22) Filed: Dec. 19, 2000

(51) Int. Cl. G06F 13/00

(52) U.S. Cl. 711/171

(57) ABSTRACT

A FIFO memory having multiple buffer areas formed therein, and boundary pointers for defining the size of each buffer area. The FIFO memory also includes a controller operable for dynamically varying the value of each boundary pointer in accordance with the amount of incoming data to be stored in a given buffer area during the operation of the device so as to allow for maximum utilization of the memory space.

### FIELD OF THE INVENTION

The present invention relates to first-in, first-out (FIFO) memories, and more particularly to a dynamically programmable FIFO memory which allows for the size/depth of different sectors/buffers to vary during system operation.

### BACKGROUND OF THE INVENTION

First-in, first-out (FIFO) buffers are well known in the art, and are typically utilized to transfer data between two distinct data systems, each of which operates under control of an independent clock signal. In most instances, the data system forwarding data writes the data into the FIFO memory, while the data system receiving the data reads the data out of the FIFO memory in the order in which it was written into the memory.

It is also known to form FIFOs utilizing a ring buffer structure. In accordance with the operation of a ring buffer, a fixed area of memory can be continuously and circularly accessed by utilizing a read pointer (RP) and a write pointer (WP). FIGS. 1(a)-1(d) illustrate the general operation of a ring buffer memory. FIG. 1(a) illustrates an empty buffer. As shown, both the read pointer 2 and the write pointer 4 are at the same location when the buffer is empty. However, as shown in FIG. 1(b), as data is written into the buffer, the write pointer 4 advances clockwise. Specifically, the address of the write pointer 4 is advanced by one when the write operation ends, such that the address of the write pointer 4 is set at the next available memory location. It is noted that the read pointer 2 does not move when data is being read into the ring buffer.

FIG. 1(c) illustrates an example where data has been both written to the buffer and read from the buffer. As shown, as data is written into the buffer, the write pointer 4 continues to advance. However, in a similar fashion, as data is read from the buffer, the read pointer 2 advances. As with the write pointer, the address of the read pointer advances by one when the read operation is complete such that the read pointer 2 is set at the next memory location to be read.

FIG. 1(d) illustrates an example where the ring buffer is full. As shown, data has been written into all of the available memory. At this point, the controller (not shown) prevents further incrementing of the write pointer 4, and the further writing of data, so as to prevent data which still needs to be read out of the buffer from being written over.

It is also known to arrange for the operation of multiple FIFOs within a single ring buffer so as to accommodate applications processing distinct data segments, as well as to maximize the utilization of memory. For example, when attempting to store data A and data B, each of which has a maximum memory requirement of 1 kbyte, if during normal operation data A and data B typically require less than 1 kbyte of memory, it may be possible utilize a single 1 kbyte FIFO.

FIG. 2(a) illustrates an example of a FIFO capable of storing multiple data segments. As shown, the FIFO comprises two write pointers WPa, WPb, and two read pointers, RPa, RPb, thereby forming two FIFOs (i.e., FIFO A and FIFO B) in the ring buffer. Each pair of read/write pointers (e.g., RPa/WPa) operate in the same manner as the read/write pointers described above with reference to FIG. 1. The ring buffer of FIG. 2(a) advantageously allows for storage of both data A and data B, and as illustrated in the example of FIG. 2(a), both FIFO A (i.e., RPa/WPa) and FIFO B (i.e., RPb/WPb) contain data. As a result of the foregoing structure, as mentioned above, even though data A and data B require a maximum storage capacity of 1 kbyte, because during normal operation the actual storage requirements for data A and data B are less than 1 kbyte, both data A and data B can be stored in the ring buffer illustrated in FIG. 2(a) which comprises only 1 kbyte of available memory space.

Notwithstanding the fact the foregoing FIFO having multiple read and write pointers operates to increase the overall efficiency and utilization of the memory space allocated for the FIFO, various deficiencies and problems still exist. More specifically, in such devices, each read/write pointer combination typically has associated boundaries that function to define or limit the amount of space within the FIFO that a given data segment can be written in. For example, the boundaries may be set such that each data segment is afforded half of the FIFO memory. It is noted, however, that once the boundaries are set, they are fixed and not adjustable during operation of the device. The use of such fixed boundaries often result in the under-utilization of the available memory space. For example, in the event data A completely fills FIFO A, even though FIFO B is empty, data storage regarding data segment A will be halted because data A cannot be stored in FIFO B.

FIG. 2(b) illustrates an example of a two FIFO ring buffer, wherein read pointer B functions as a boundary for FIFO A, and read pointer A functions as a boundary for FIFO B. In other words, data A can be written into FIFO A until write pointer A reaches read pointer B. If read pointer B advances, then additional data can be written into FIFO A. FIFO B operates in the same manner, with read pointer A acting as a boundary for FIFO B.

The operation of the FIFO illustrated in FIG. 2(b) also results in an under-utilization of the available memory space. For example, referring to FIG. 2(b), as additional data is written into FIFO A, the write pointer of FIFO A reaches the read pointer of FIFO B, at which time the system controller prevents additional data from being stored in FIFO A. However, as shown in FIG. 2(b), FIFO B still has un-utilized memory space available to store additional data. Unfortunately, this available memory space cannot be allocated to FIFO A due to the boundary structure of the device.

Another known prior art FIFO device, as described in U.S. Pat. No. 5,097,442, discloses allowing a programmer to pre-program the depth of a given FIFO in accordance with a specific application. The device allows for more efficient use of the overall memory structure by providing the programmer the ability to allocate only a predefined portion of the memory for use as a FIFO, while allowing the remaining memory to be utilized for other purposes. As set forth in the patent, the depth pointer is set equal to the read pointer plus some predetermined fixed number.

While the foregoing known FIFO devices allow for some manipulation of the memory space designated for use, there is still a need to further maximize the efficiency and utilization of the FIFO memory. As explained above, each of the foregoing FIFO devices have operating scenarios wherein substantial portions of the memory space allocated to the FIFO device remains un-utilized.

Accordingly, there is exists a need for a FIFO device and a FIFO memory controller that minimizes the un-utilized memory during operation of the FIFO device, thereby increasing the overall efficiency and utilization of the device.

### SUMMARY OF THE INVENTION

In an effort to solve the aforementioned needs, it is an object of the present invention to provide a FIFO memory device that minimizes the un-utilized memory during operation of the device.

More specifically, the present invention relates to a FIFO memory having multiple buffer areas formed therein, and boundary pointers for defining the size of each buffer area. Importantly, each boundary pointer can be dynamically varied in accordance with the amount of incoming data to be stored in a given buffer area during the operation of the device so as to allow for maximum utilization of the memory space.

In one exemplary embodiment, the first-in, first-out memory device of the present invention comprises: a memory array having a plurality of address locations for storing incoming data; a first boundary pointer for indicating an end point of a first buffer area formed within the memory array into which the incoming data can be stored; a second boundary pointer for indicating an end point of a second buffer area formed within the memory array into which the incoming data can be stored; and a controller for adjusting the value of the first boundary pointer and the second boundary pointer in accordance with the amount of incoming data to be stored.

In another exemplary embodiment, the present invention relates to a method of storing data in a first-in, first-out memory device. The method comprises the steps of: defining a memory array having a plurality of address locations for storing incoming data; defining a first boundary pointer for indicating an end point of a first buffer area formed within the memory array into which the incoming data can be stored; defining a second boundary pointer for indicating an end point of a second buffer area formed within the memory array into which the incoming data can be stored; and adjusting the value of the first boundary pointer and the second boundary pointer in accordance with the amount of incoming data to be stored.

As described in further detail below, the present invention provides significant advantages over the prior art. Most importantly, the FIFO memory device of the present invention minimizes the un-utilized memory during operation of the FIFO device, thereby increasing the overall efficiency and utilization of the device.

Moreover, by increasing the efficiency of operation of the FIFO device, the present invention allows for a reduction in the overall memory requirements of any device incorporating the FIFO of the present invention, thereby providing a savings with regard to both cost and space.

In addition, by providing the dynamically movable boundary pointers, the eliminates the need for the designer/programmer to attempt to estimate the amount of FIFO memory needed for a specific task, which is required when utilizing prior art devices.

Additional advantages of the present invention will become apparent to those skilled in the art from the following detailed description of exemplary embodiments of the present invention.

The invention itself, together with further objects and advantages, can be better understood by reference to the following detailed description and the accompanying drawings.

### BRIEF DESCRIPTION OF THE DRAWINGS

FIGS. 1(a)-1(d) illustrate the general operation of a conventional FIFO memory utilizing a ring buffer.

FIGS. 2(a)-2(b) illustrate the general operation of a conventional FIFO memory comprising a ring buffer having two FIFO memories.

FIG. 3 illustrates an exemplary embodiment of the FIFO memory of the present invention.

FIGS. 4(a)-4(h) illustrate the general operation of the FIFO memory of the present invention.

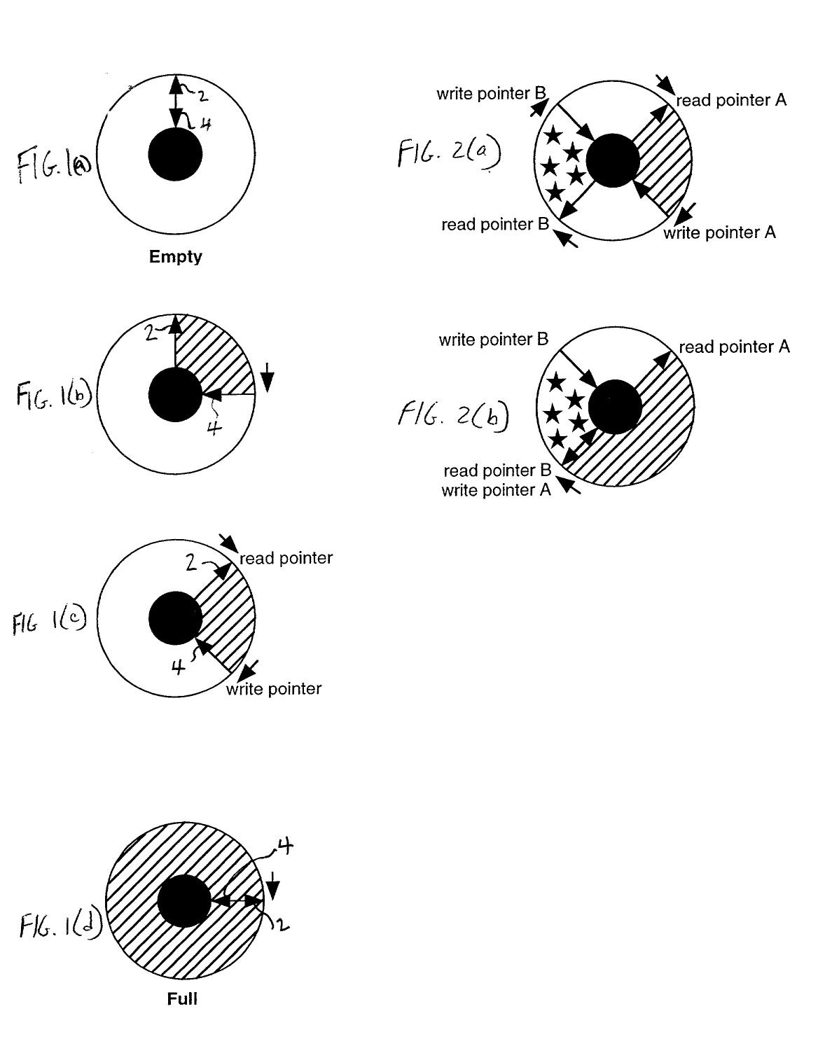

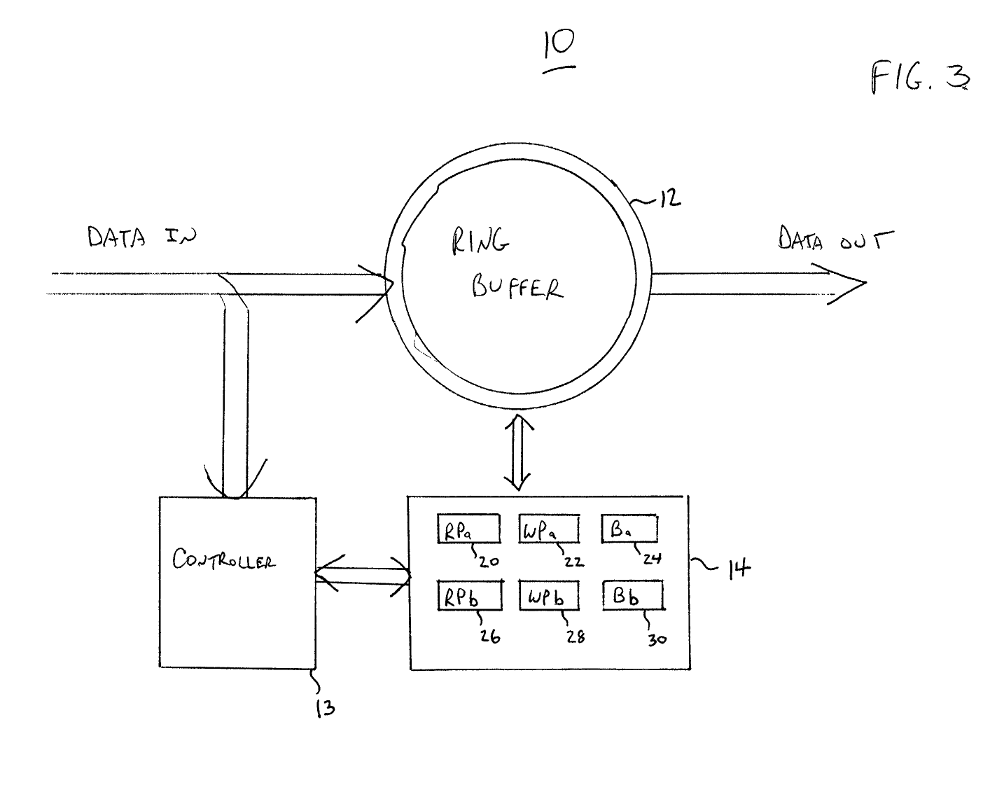

### DETAILED DESCRIPTION OF THE INVENTION

FIG. 3 illustrates an exemplary embodiment of the FIFO memory device of the present invention. As shown, the FIFO memory device 10 comprises a ring buffer 12 having means for accepting data (i.e., writing data) and for outputting data (i.e., reading data). In the current embodiment, the ring buffer 12 is configured to comprise two separate FIFO memories, namely, FIFO A and FIFO B. The device 10 further comprises a plurality of pointers 14, which function to define the boundaries of each of the FIFO memories, as well as to define the read pointers and write pointers of each FIFO. Specifically, the pointers associated with FIFO A are: (1) read pointer A (RPa) 20, which indicates the next memory location in FIFO A to be read from FIFO A, (2) write pointer A (WPa) 22, which indicates the next memory location in FIFO A to receive incoming data, and boundary pointer (Ba) 24, which indicates the end of the memory space allocated to FIFO A at a given instant in time. Similarly, the pointers associated with FIFO B are: (1) read pointer B (RPb) 26, which indicates the next memory location in FIFO B to be read from FIFO B, (2) write pointer B (WPb) 28, which indicates the next memory location in FIFO B to receive incoming data, and boundary pointer (Bb) 30, which indicates the end of the memory space allocated to FIFO B at a given instant in time. It is noted that the components utilized to form the pointers can be, for example, a register or any other suitable memory device.

The device 10 further comprises a controller 13, which is coupled to the FIFO pointers 14 and which functions to dynamically define the size of both FIFO A and FIFO B so as to maximize the utilization of each FIFO. The controller 13 can be formed utilizing a microprocessor or any other suitable processing unit. It is noted that the operations concerning the reading and/or updating of the read and write pointers associated with each FIFO is accomplished in the same manner as conventional FIFO memories, and therefore is not discussed in detail herein.

As stated above, the memory location defined by boundary A functions to define the end of the memory space allocated to FIFO A. Similarly, the memory location defined by boundary B functions to define the end of the memory space allocated to FIFO B. In accordance with the present invention, the controller 13 functions to dynamically vary the value of boundary A (i.e., boundary pointer Ba) and boundary B (i.e., boundary pointer Bb) in conjunction with the amount of incoming data directed to either FIFO A (referred to as data A) or FIFO B (referred to as data B). By dynamically varying the size of both FIFO A and FIFO B on the basis of the amount of incoming data, the present invention provides for substantially improved utilization of the memory space contained in the ring buffer 12.

More specifically, as data is read into a given FIFO, the controller 13 determines the amount of data received and attempts to enlarge the given buffer area (i.e., either FIFO A or FIFO B) by a predetermined amount. For example, assuming data is read into FIFO A, the controller 13 will attempt to enlarge FIFO A by resetting the value of boundary A. Assuming boundary A is not adjacent data stored in FIFO B (i.e., there is available space in FIFO B so as to allow boundary A to be advanced), boundary A is reset so as to increase the overall memory space afforded FIFO A. It is noted, however, that in the event that FIFO B is full, then the controller 13 would not attempt to reset boundary A. The status of either FIFO (i.e., empty, full, half-full, etc.) can be readily determined by the controller 13 by checking the values of the read/write pointers of a given FIFO and the current boundary value.

Of course, the alternative to the foregoing scenario is also possible. For example, assuming boundary A had been advanced as the result of prior data A being input into FIFO A and no data has been read from FIFO A such that boundary B cannot currently be further advanced, if FIFO A is not full and data B is now input into FIFO B, the controller 13 will reset boundary A so as to retract boundary A, thereby decreasing the space allocated to FIFO A and increasing the space allocated to FIFO B. Once again, the amount to retract boundary A is governed by the amount of data to be input into FIFO B.

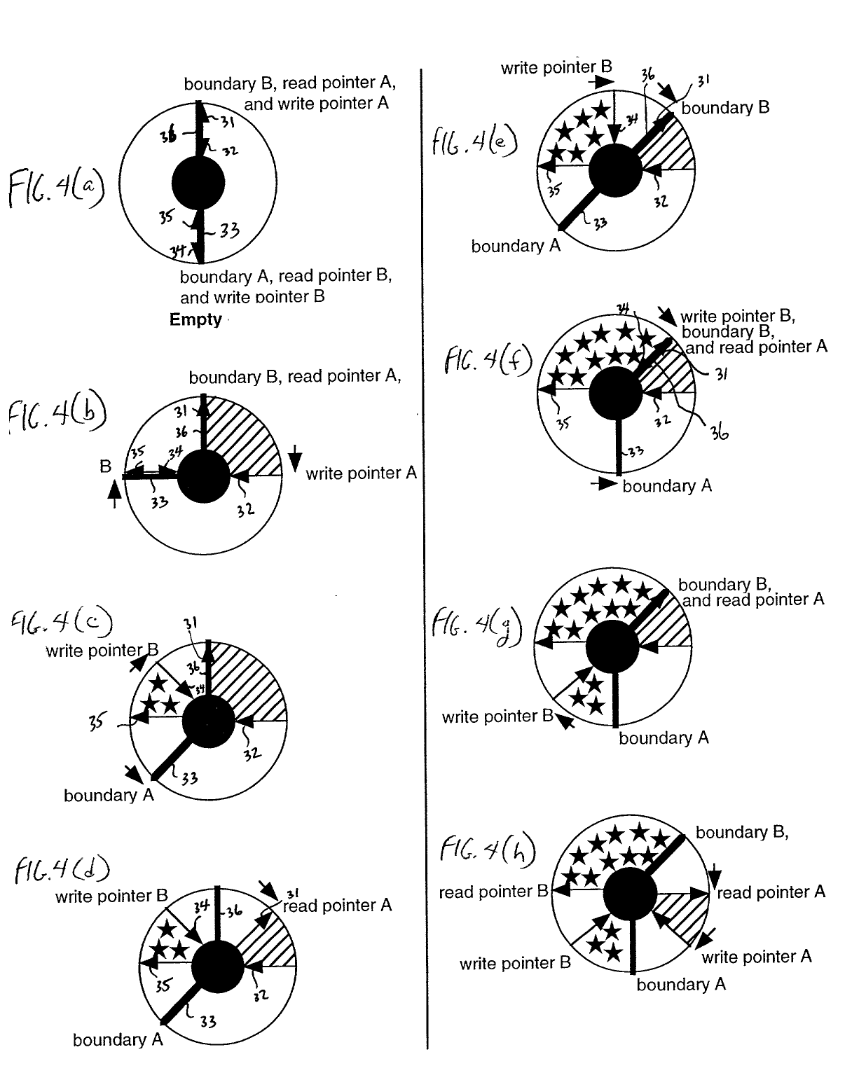

As noted above, the amount that the controller 13 functions to advance or retract a given boundary is governed in accordance with the amount of data to be input into a given FIFO. For example, in the embodiment of the present invention set forth in FIG. 4(a)-4(h), there is a 1:1 correspondence. However, it should be understood that other possibilities exist. For example, the controller 13 could be programmed to move the boundaries a set amount that is not related to the amount of incoming data. Alternatively, the controller could be programmed to move the boundaries in other than a 1:1 correspondence with the incoming data. Moreover, it is also possible to program the controller 13 such that the size of FIFO A and FIFO B are not allowed to be decreased below some predefined minimum size.

By dynamically varying the boundaries of both FIFO A and FIFO B, the present invention advantageously allows for maximum utilization of the overall memory space contained in the ring buffer 12. Indeed, the present invention utilizes the practical reality of data processing to maximize the use of the available FIFO memory. Specifically, assuming the tasks generating data A and data B are not continuously performed simultaneously, when performing task A, data A will likely require a majority of space in the FIFO memory, and visa versa, when task B is performed. The present invention allows for the allocation of the memory to be predominately for use by FIFO A at a given time, and by FIFO B at a separate time. Thus, by increasing the efficiency of the memory use, the present invention effectively increases the memory space available for both FIFO A and FIFO B without having to increase the actual memory requirements of the system.

FIGS. 4(a)-4(g) illustrate various examples of the operation of the FIFO memory device of the present invention. As stated above, the FIFO memory device of the present invention provides for dynamically movable boundaries, which move in accordance with the amount of incoming data, so as to provide for maximum utilization of the memory space allocated to the FIFO memory device.

FIG. 4(a) illustrates an exemplary ring buffer utilizing the present invention. The ring buffer has two FIFOs and comprises read pointer A (RPa) 31, write pointer A (WPa) 32; boundary pointer A 33, read pointer B (RPb) 34, write pointer B (WPb) 35, and boundary pointer B 36. Initially, as shown in FIG. 4(a), when there is no data in either FIFO A or FIFO B, each FIFO is allocated half of the available memory space. RPa and WPa are at the same location, and boundary pointer B (i.e., the last memory location available for storing data B in FIFO B) is defined by RPa. In particular, the last available memory location for FIFO B is the memory address location which equals RPa minus 1. RPb, WPb and boundary A are defined in a similar.

Referring now to FIG. 4(b), as data begins to come into FIFO A, WPa begins to move in the same manner as explained above with regard to prior art devices. However, in accordance with the present invention, RPb, WPb and boundary A also move so as to allow for additional memory space to be allocated for FIFO A. In one embodiment, the amount RPb, WPb and boundary A move is equal to the amount WPa moved to accommodate the incoming data. As a result, in the example shown in FIG. 4(b), as the data stored in FIFO A occupied 1/4 of the total memory space, the RPb, WPb and boundary A were also moved 1/4 of the total memory space. It is noted that it is of course possible to program the device such that the amount the RPb, WPb and boundary A move in response to data coming into FIFO A is something other than a 1:1 correspondence.

Continuing with the current example and referring to FIG. 4(c), assuming now that data begins to be stored in FIFO B, as illustrated by the movement of WPb, the system attempts to move boundary A backward in an amount equal to the amount WPb has just moved. The backward movement of boundary A functions to increase the memory space currently available for FIFO B. It is noted that both FIFO A and FIFO B “wrap-around”. In other words, referring to FIG. 4(c), assuming data continues to be stored in FIFO B and no data has been read out of FIFO A such that data A is currently adjacent boundary B (as such, boundary B cannot be moved), when WPb reaches boundary B, as there is still memory space available in FIFO B (i.e., the portion defined by boundary A and RPb), data B will continue to be stored in FIFO B in the memory locations defined between boundary A and RPb.

Referring now to FIG. 4(d), continuing the example, assuming now that data is read out of FIFO A, which is illustrated by the movement of RPa, there is no adjustment of either boundary A or boundary B. However, referring to FIG. 4(e), as new data is read into FIFO B, because RPa is no longer adjacent boundary B (as shown in FIG. 4(d)), boundary B is moved in an amount equal to the amount of incoming data B, in the same manner that boundary A was moved in FIG. 4(b). It is noted that in the present embodiment, in the event the amount of data being input into FIFO B exceeds the space available to move boundary B, boundary B is simply moved the maximum amount (i.e., until boundary B is adjacent RPa). Alternatively, it is also possible move boundary A backward (assuming boundary A is not adjacent any data stored in FIFO A) such that the forward movement of boundary B and the backward movement of boundary A equals the space corresponding to the new incoming data B.

Continuing the current example as shown in FIG. 4(f), assuming now that additional data continues to be input into FIFO B such that the WPb is adjacent boundary B, and boundary B is adjacent read pointer A, the present invention moves boundary A backward to as to increase the available memory for FIFO B. In the present embodiment, boundary A is moved in an amount equal to the amount of new incoming data B. It is also noted again, that boundary A can only be moved backward if data A is not adjacent the boundary A. As shown in FIG. 4(g), in the event additional data is written into FIFO B, the data is stored starting adjacent boundary A and in a clockwise direction thereafter as illustrated by the movement of WPb.

Finally, referring to FIG. 4(h), assuming more data is written into FIFO A and some data is read from FIFO A as illustrated by the movement of the RPa and WPa, because data B is adjacent both the boundary A and the boundary B, in this instance there is no movement of the boundaries. As set forth above, in the event data is adjacent a given boundary, the boundary cannot be moved.

Of course, the foregoing examples illustrated in FIGS. 4(a)-4(h) are intended to illustrative, and not limiting in any manner whatsoever. Indeed, as would be apparent to someone skilled in the art, it is possible to program the controller to move the boundary in accordance with various predetermined rules. For example, in one embodiment, only boundary A is dynamically varied, and boundary B is always fixed. In another embodiment, the amount the boundaries move in response to incoming data is other than a 1:1 correspondence. Clearly, numerous other possibilities exist.

Additional variations are also possible. For example, the present invention is not limited to implementation in a ring buffer. In addition, it is possible to implement additional FIFOs (i.e., more than 2), by increasing the number of read and write pointers and boundaries accordingly, and by programming the controller in the necessary manner to accommodate the additional pointers and boundaries.

As described above, the dynamically programmable FIFO memory of the present invention provides significant advantages over the prior art. Most importantly, the FIFO memory device of the present invention minimizes the un-utilized memory during operation of the FIFO device, thereby increasing the overall efficiency and utilization of the device. Moreover, by increasing the efficiency of operation of the FIFO device, the present invention allows for a reduction in the overall memory requirements of any device incorporating the FIFO of the present invention, thereby providing a savings with regard to both cost and space.

In addition, by providing the dynamically movable FIFO boundaries, the present invention eliminates the need for the designer/programmer to attempt to estimate the amount of FIFO memory needed for a specific task, which is required when utilizing prior art devices.

Although certain specific embodiments of the present invention have been disclosed, it is noted that the present invention may be embodied in other forms without departing from the spirit or essential characteristics thereof. The present embodiments are therefor to be considered in all respects as illustrative and not restrictive, the scope of the invention being indicated by the appended claims, and all changes that come within the meaning and range of equivalency of the claims are therefore intended to be embraced therein.

I claim:

1. A first-in, first-out memory device comprising:
a memory array having a plurality of address locations for storing incoming data;
a boundary pointer for indicating an end point of a buffer area formed within said memory array into which said incoming data can be stored; and
a controller for adjusting the value of said boundary pointer in accordance with the amount of incoming data to be stored.

2. The first-in, first-out memory of claim 1 further comprising:
a read pointer, coupled to said memory array, for indicating a read address of said buffer area; and
a write pointer, coupled to said memory area, for indicating a write address of said buffer area.

3. The first-in, first-out memory of claim 1, wherein said memory array is implemented utilizing a ring buffer.

4. The first-in, first-out memory of claim 3, wherein said controller operates to move said boundary pointer so as to increase the size of said buffer on the basis of a 1:1 correspondence with the amount of incoming data.

5. The first-in, first-out memory of claim 1, wherein said controller dynamically varies the value of said boundary pointer during operation in response to the amount of said incoming data to be stored.

6. A first-in, first-out memory device comprising:
a memory array having a plurality of address locations for storing incoming data;
a first boundary pointer for indicating an end point of a first buffer area formed within said memory array into which said incoming data can be stored;
a second boundary pointer for indicating an end point of a second buffer area formed within said memory array into which said incoming data can be stored; and
a controller for adjusting the value of said first boundary pointer and said second boundary pointer in accordance with the amount of incoming data to be stored.

7. The first-in, first-out memory of claim 6 further comprising:
a first read pointer, coupled to said memory array, for indicating a read address of said first buffer area;
a first write pointer, coupled to said memory area, for indicating a write address of said first buffer area a second read pointer, coupled to said memory array, for indicating a read address of said second buffer area; and
a second write pointer, coupled to said memory area, for indicating a write address of said second buffer area.

8. The first-in, first-out memory of claim 6, wherein said memory array is implemented utilizing a ring buffer.

9. The first-in, first-out memory of claim 8, wherein said controller operates to move said first boundary pointer and said second boundary pointer so as to increase the size of said first buffer and said second buffer on the basis of a 1:1 correspondence with the amount of incoming data.

10. The first-in, first-out memory of claim 6, wherein said controller dynamically varies the value of said first boundary pointer and said second boundary pointer during operation in response to the amount of said incoming data to be stored.

11. A method of storing data in a first-in, first-out memory device, said method comprising the steps of:
providing a memory array having a plurality of address locations for storing incoming data;
defining a boundary pointer for indicating an end point of a buffer area formed within said memory array into which said incoming data can be stored; and
adjusting the value of said boundary pointer in accordance with the amount of incoming data to be stored.

12. The method of storing data in a first-in, first-out memory of claim 11, further comprising the step of:
defining a read pointer for indicating a read address of said buffer area; and
defining a write pointer for indicating a write address of said buffer area.

13. The method of storing data in a first-in, first-out memory of claim 11, wherein said memory array is implemented utilizing a ring buffer.

14. The method of storing data in a first-in, first-out memory of claim 13, wherein said boundary pointer is modified so as to increase the size of said buffer on the basis of a 1:1 correspondence with the amount of incoming data.

15. The method of storing data in a first-in, first-out memory of claim 11, wherein the value of said boundary pointer is dynamically varied during operation in response to the amount of said incoming data to be stored.

16. A method of storing data in a first-in, first-out memory device, said method comprising the steps of:
defining a memory array having a plurality of address locations for storing incoming data;
defining a first boundary pointer for indicating an end point of a first buffer area formed within said memory array into which said incoming data can be stored;
defining a second boundary pointer for indicating an end point of a second buffer area formed within said memory array into which said incoming data can be stored; and
adjusting the value of said first boundary pointer and said second boundary pointer in accordance with the amount of incoming data to be stored.

17. The method of storing data in a first-in, first-out memory of claim 16 further comprising the step of:
defining a first read pointer for indicating a read address of said first buffer area;
defining a first write pointer for indicating a write address of said first buffer area defining a second read pointer for indicating a read address of said second buffer area; and
defining a second write pointer for indicating a write address of said second buffer area.

18. The method of storing data in a first-in, first-out memory of claim 16, wherein said memory array is implemented utilizing a ring buffer.

19. The method of storing data in a first-in, first-out memory of claim 18, wherein said first boundary pointer and said second boundary pointer are adjusted so as to increase the size of said first buffer and said second buffer on the basis of a 1:1 correspondence with the amount of incoming data.

20. The method of storing data in a first-in, first-out memory of claim 16, wherein said first boundary pointer and said second boundary pointer are dynamically varied during operation in response to the amount of said incoming data to be stored.
